(19) United States
(12) Patent Application Publication
(10) Pub. No.: US 2022/0243758 A1
(43) Pub. Date: Aug. 4, 2022

(54) COMBINATION NUT ASSEMBLY CAPABLE OF PREVENTING LOOSENING THEREOF

(71) Applicant: TAKASHO GIKEN CO., LTD., Fuefuki-shi (JP)

(72) Inventor: Takahumi SUZUKI, Fuefuki-shi (JP)

(21) Appl. No.: 17/586,943

(22) Filed: Jan. 28, 2022

(30) Foreign Application Priority Data
Jan. 30, 2021 (JP) 2021-49273

(51) Int. Cl. F16B 39/12; F16B 41/00; F16B 33/02

(52) U.S. Cl. CPC F16B 39/12; F16B 33/02; F16B 41/002

(57) ABSTRACT

A combination nut assembly includes first and second tightening nuts, each engageable with a bolt and having an interior frustum-shaped fitting socket and a dual frustoconical locking nut engageable with the bolt and elastically deformable and consists of two exterior frustum-shaped half locking nut members identical in geometric configuration and symmetrically inverted in position integrally connected together as a single part with their larger ends jointly connected and located between the first and second tightening nuts when assembled. Each half locking nut member protrudes an axial distance “e” from a bearing surface of the tightening nut in an assembled position. Axial distance “e” is defined by p>e≥α/tan θ, where: “θ” is cone generating angle; “α” is perpendicular backlash between flanks of threads of the bolt and locking nut in an ordinarily engaged position; and “p” is locking nut pitch.

### CROSS-REFERENCE TO RELATED APPLICATION

This application claims priority to JP Patent Application No. 2021-49273 filed Jan. 30, 2021, the entire contents of which are hereby incorporated by reference.

### FIELD OF THE INVENTION

The present invention relates to a combination nut assembly constituting a bolt-and-nut fastening device together with a fastening bolt for firmly and securely fastening and fixing connection members to be fastened which is able to prevent loosening thereof resulting from reversed rotation and, more particularly, to a combination nut assembly consisting of three individual nut components, i.e. a pair of outer tightening nuts and a frustoconical inner locking nut, which yields high tightening performance, besides it facilitates highly reliable and efficient loosening prevention properties thereof.

### BACKGROUND OF THE INVENTION

Fastening devices such as bolt-and-nut fastening devices for fastening and fixing connection members to be fastened firmly and securely are well known in the art. The bolt-and-nut fastening device consists of a fastening bolt which is penetrated through the connection members and a tightening nut engageable with the fastening bolt. The connection members are held down between a bearing surface of the fastening bolt and the nut and fixed firmly and securely with axial tension (axial fastening force) of the fastening bolt which is caused by tightening the nut on the fastening bolt. In the case where the bolt-and-nut fastening device is employed for fixing or connecting connection members of a structure exposed to mechanical vibrations, repetitive variable loads and/or impact loads, one of unavoidable features of the bolt-and-nut fastening device is that the tightening nut causes no loosening. Loosening of the tightening nut develops a decrease in axial tension of the fastening bolt which leads to an unignorable decrease in fastening force of the bolt-and-nut fastening device.

Loosening of the bolt-and-nut fastening device is roughly divided into three categories; namely loosening developed by reversed rotation (rotation-derived loosening) which is relative rotation in an unscrewing direction between the fastening bolt and the nut, loosening unrelated to reversed rotation (non-rotation loosening) and loosening due to permanent deformation or permanent strain. Among them, loosening that encounters possibly so often is the rotation-derived loosening caused with such loads as externally applied in a direction perpendicular to an axis of the fastening bolt, in a circumferential direction of the fastening bolt and/or in a direction heading toward the axis of the bolt-and-nut fastening device. When encounters such rotation-derived looseness, the bolt-and-nut fastening device induces a decrease in fastening force and, under sever work circumstances, makes not only deterioration of its own essential functions including fastening capability but also causes fatigue failures or omissions of the fastening bolts which are possibly accompanied by a decline in reliability and safety of large structures.

In order to deal with an occurrence of the rotation-derived loosening of the bolt-and-nut fastening device which is accompanied by a risk of decreasing the axial tension (axial fastening force), it is an ordinary way to equip the bolt-and-nut fastening device with a washer in a fastening place between a bolt head or a tightening nut and the connection members to be fastened or a lock nut having a special mechanism for preventing the tightening nut from causing relative rotation, or to employ a so-called double nut means used so as to avoid a risk of a decline in fastening force. However, in the case where the bolt-and-nut fastening device is employed for fastening connection members of large or heavy structures, for example, large iron bridges, elevated expressways, steel towers, motors or engines including electric motors, wind motors, hydraulic engines and heat engines, transportation machinery equipped with these motors or engines such as marine vessels, aircrafts, railroad vehicles, automobiles and the like which are all exposed to various types of fluctuating stress such as caused by mechanical vibrations, even a slight rotation-derived loosening causes the bolt-and-nut fastening device to yield a decrease in axial fastening force unignorable to strength and reliability of the structures, resulting in that the structures encounter serious defects in capability and safety and, if considerable, that there arises not only possible danger of malfunction of the bolt-and-nut fastening device but also fatigue breakdown or omission thereof which might induce serious accidents of the structures. Because of this, it is unavoidable to carry out periodic inspection for the bolt-and-nut fastening devices and, when rotation-derived loosening is found, the bolt-and-nut fastening device has to be tightened again or will be replaced with a new one depending on certain circumstances.

There have been proposed various double lock nuts for preventing the rotation-derived loosening. For instance, Japanese Patent Bulletin No. 6096420 discloses a double lock nut structure which consists of a first nut made of a nut portion and a cylindrical barrel portion extending from the nut portion both of which are formed with an internal screw threads for engagement with the threaded bolt and a second nut engageable with the bolt which has a hollow housing for stowing the barrel portion therein. The barrel portion of the first nut is provided with a circumferential projection on its hem and slots dividing the barrel portion into a plurality of segments so as to be elastically deformable in a radial direction. The hollow housing has a tapered opening surface whose end opening is smaller in diameter than the circumferential projection. The lock nut structure is adapted so that, when the first nut is connected to the second nut by inserting and fitting the cylindrical barrel in the hollow housing, the cylindrical barrel is radially deformed through sliding of the circumferential projection on the surface of the tapered opening and consequently, tightly grasped by the declining tapered opening, resulting in development of locking between the first nut and the bolt. Further, a lock nut structure disclosed in Japanese Utility Model Bulletin 30(1954)-10815 is of a twine type of double nut structure which consists of a dual-head male nut engageable with a threaded bolt and a pair of female nuts engageable with the threaded bolt. The dual-head male nut consists of a flange and fitting protrusions extending from the flange on both sides which are symmetrically disposed and integrally formed together with the flange and is provided with a vertical slot. Each female nut is provided with a frustoconical fitting recess which is fit by the fitting protrusion of the dual-head male nut. For fastening the double nut, screwed onto the bolt is either one of the female nuts first, subsequently the male nut, and finally the other female nut, so as to develop triple engagement in the twin doble nut structure. In the triple engagement, the male nut is engaged as a middle functional member between the pair of the female nuts on both sides so as to fit and fasten the protrusions in the frustoconical fitting recess.

The double lock nut structure Japanese Patent Bulletin No. 6096420 discloses is locked through diametrical deformation of the cylindrical barrel of the first nut caused through sliding of the circumferential projection on the declining tapered opening of the second nut. Because the protrusion hem of the first nut is shorter in axial length compared with the screw thread or the slots, radial deformation of the cylindrical barrel of the first nut caused by the circumferential projection is ununiform in the axial direction, so that radial force for stressing the cylindrical barrel of the first nut against the bolt is made correspondingly ununiform in the axial direction. This ununiform radial stress provides highly unstable locking between the first nut and the bolt, resulting in possible occurrence of rotation-derived loosening between the first nut and the fastening bolt. The lock nut structure causes big workloads and/or complicated works for workers in work fields, in particularly inferior work fields where large constructions such as large bridges, elevated expressways and the like are built. These works are undesirable from a viewpoint of safety. Further, because the first nut has an integral construction of the polygonal nut portion and the cylindrical barrel and, in addition, is complicated in geometric shape, there are induced difficulties such as troublesome manufacturing processes, large man-hour and increased manufacturing cost as compared with conventional lock nut structures.

A twin type double lock nut Japanese Utility Mode Bulletin 30(1954)-10815 discloses is used in such a manner as to engage either one of the twin female nuts firsts, then a male nut and finally the other female nut with a threaded bolt in this order. After engaging and screwing down the first nut on the bolt, the twin type lock nut at one end is engaged and screwed down on the threaded bolt, and then the other female nut is engaged and screwed down on the threaded bolt. While the male nut at one end is screwed down, the one fustoconical fitting projection of the male nut is pressed into a frustoconical fitting recess of the one female nut, it is pinched radially by the fustoconical fitting recess, so as to be elastically deformed in the radial direction. Similarly, while the other female nut is engaged and screwed down on the threaded bolt, the other projection of the male nut is pressed into the fustoconical fitting recess of the other female nut, so that the other projection is pinched radially by the fustoconical fitting recess, so as to be elastically deformed radially. In the fastening operation of the twin type double lock nut which is excellent and unique distinctively from a viewpoint of triple engagement, the engagement between the male nut and the female nut is relatively long in distance and needs a large number of rotations of each individual nut. In addition, the twin type double lock nut requires engaging operations three times for achieving the triple engagement effect. Accordingly, in order to complete fastening of the twin type double lock nut, the tightening operation of a large number of rotations should be repeated three times. Further, each tightening operation for long engagement between the male nut and the female nut requires a large tightening torque. In particularly inferior work fields where a large structure such as a large bridge, elevated expressway or a similar structure is built, a quite large number of lock nuts are used for fastening and fixing connection members of the large structure, repeating the fastening operation three times for every twin type double lock nut is quite undesirable from a viewpoint of safety and work efficiency.

There are many work fields where a large structure such as a large bridge, an elevated expressway or the like needs a huge number, dozens or several hundreds, of the lock nuts depending on the structure. In such a work field, after installation of a necessary number of threaded bolts in an intended area and subsequent tightening of either one of the twin double lock nut onto each threaded bolt, the male nuts are engaged and screwed down into all of the tightened female nuts one by one. Although, the other female nut has to be screwed onto the male nuts, mistakes will occasionally happen in engaging the female nuts with the threaded bolts. Because these fails in fastening work possibly induces a decline in strength and reliability of the structure, the field workers are under considerable stress in the inferior work fields.

### SUMMARY OF THE INVENTION

An object of the present invention is to provide a combination nut assembly with a locking mechanism which is suitable for fastening and fixing connection members of large or heavy structures exposed frequently to various types of fluctuating stress such as caused by mechanical vibrations in sever working environments and capable of guaranteeing safety and reliability of the large or heavy structures.

Another object of the present invention is to provide a combination nut assembly which requires a relatively weak tightening torque accompanied by easy and brief operations only for fastening and firmly fixing connection members of the large or heavy structures and allows low production costs.

In accordance with the present invention, the foregoing objects are characterized in that the combination nut assembly used together with a threaded fastening bolt for fastening connection members to be fixedly connected consists of a pair of outer tightening nuts identical in geometric configuration to each other each of which is provided with an internally threaded through bore engageable with the threaded fastening bolt and a frustum-shaped fitting socket in the shape of an interior frustum with a larger diameter end opening to the exterior and a smaller diameter end opening to the through threaded bore and a dual frustoconical inner locking nut comprising two barrels provided with threaded bores respectively engageable with the threaded fastening bolt and a slot formed in the hollow barrel wall and extending over its axial length. The dual frustoconical inner locking nut consists of two halves of the cylindrical hollow barrel each of which is shaped in an external frustum. Although, the frustoconical inner locking nut appears as if it consists of two individual frustum-shaped half locking nut members which are in a reversed and symmetrical position and connected to each other at their larger diameter ends, these frustum-shaped half locking nut members, which are identical in geometric configuration to each other, are integrally connected at their larger diameter ends as an integrated single unit and have a common larger diameter end. In other words, the frustoconical inner locking nut has an external appearance like a dual headed nut. On the basis of this external appearance, the frustoconical inner locking nut is referred to as a dual frustoconical inner locking nut. Both the frustum-shaped half locking nut members of the dual frustoconical inner locking nut have the same generating line angle as the frustum-shaped fitting socket, a cone height smaller than a depth of the frustum-shaped fitting socket, a larger end diameter larger than that of the frustum-shaped fitting socket and a smaller end diameter smaller than that of the larger end diameter of the frustum-shaped fitting socket.

This combination nut assembly is engaged with the fastening bolt with fingers by means of holding either one of first and second outer tightening nuts first, then the dual frustoconical inner locking nut and the other of the first and second outer tightening nuts finally, so that a second frustum-shaped half locking nut member is fit by and partially stowed in the frustum-shaped fitting socket of the other or second outer tightening nut and, simultaneously, a frustum-shaped first half locking nut member is fit by and partially stowed in the frustum-shaped fitting socket of the outer tightening nut. When these three nut components are placed in a preparatory position where the combination nut assembly is ready for subsequent fastening and fixing operation of the connection members. In this preparatory position, both the frustum-shaped half locking nut members of the dual frustoconical inner locking nut are fit by and stowed in the frustum-shaped fitting sockets of the outer tightening nuts respectively so that they are properly matched up with one another without suffering any external loads. For easy understanding of the present invention, although the above description has been directed to the case where these three nut components are engaged with the fastening bolt with fingers one by one so as to be put in the preparatory position under a well-matched condition, however, it is more practical to engage the three nut components well matched in advance with the fastening bolt and locate them to the preparatory position all at once.

After positioning the combination nut assembly in the preparatory position and tightening the one or first outer tightening nut with a specified tightening torque, locking the combination nut assembly is executed by rotating the second outer tightening nut through a small angle less than 360° by the use of a tightening tool. When the second outer tightening nut is tightened as aimed, the rotation of the second outer tightening nut develops a frictional clutch function, i.e., frictional coupling to the dual frustoconical inner locking nut, more specifically to the frustum-shaped upper half locking nut member, so that the rotation of the second outer tightening nut is accompanied by rotation of the dual frustoconical inner locking nut through the frictional coupling. As a result, the dual frustoconical inner locking nut is displaced downward together with the second outer tightening nut through the engagement with the fastening bolt. Simultaneously, while this forcible rotation and downward displacement of the dual frustoconical inner locking nut is followed by the same actions as the frustum-shaped lower or first half locking nut member, whereas, because the first outer tightening nut is previously tightened against the connection members, there occurs no frictional coupling between the frustum-shaped first half locking nut member and the first outer tightening nut but sliding therebetween. When the second outer tightening nut displaces downward together with the dual fustoconical inner locking nut until making close abutment against the first outer tightening nut, while the frustum-shaped first and second half locking nut members are completely stowed in the first and second outer tightening nuts, the dual frustoconical inner locking nut is radially deformed, so that the facing flanks, namely leading and clearance flanks of the internal screw thread of the dual fustoconical inner locking nut is bitten in by a crest of the external screw thread of the fastening bolt, resulting in that the combination nut assembly is strongly locked. Because the clearance flanks of the inner and outer screw threads cause plastic deformation through the bite by the crest of the external screw thread, locking of the combination nut assembly is mechanically solidified. In addition to this mechanical lock, there occurs strong friction force or strong resistive force not only between tapered surfaces of the frustum-shaped fitting socket and tapered outer surfaces of the dual frustoconical inner locking nut but also between the bearing surfaces of the first and second outer tightening nuts. The strong resistive force is effective against relative rotation among the three nut components so as to provide additional prevention against loosening of the combination nut assembly. Accordingly, the combination nut assembly displays multiple effects such as a triple locking action, so as to guarantee the strong and reliable locking capability along the overall length that cannot be provided by conventional locking nuts or locking devices. For an enhanced multiple locking effect, it is desired to complete at least one of an outer surface of the dual frustoconical inner locking nut, an inner surface of the interior frustum-shaped fitting socket and the bearing surface of each outer tightening nut with a stain-embossed finish.

In the preparatory position, each frustum-shaped half locking nut member is stowed in the frustum-shaped fitting socket of the outer tightening nut with its hem protruding from a bearing surface of the outer tightening nut. Here, letting the cone generating angle of the interior frustum-shaped fitting socket and each exterior frustum-shaped half locking nut member be “θ”, an axial distance of the hem of each exterior frustum-shaped half locking nut member protruding from the bearing surface of each outer tightening nut when the exterior frustum-shaped half locking nut member fits in and is retained by the frustum-shaped fitting socket of the outer tightening nuts under the unloaded fit condition be “e”, and a perpendicular width of a backlash provided between clearance flanks of engaged screw threads of the fastening bolt and the dual frustoconical inner locking nut when the fastening bolt and the inner locking nut are ordinarily engaged be “α”, the axial distance “e” is determined so as to satisfy the following equation:

e=α/tan θ.

When letting a pitch of the combination nut assembly be “p”, the axial distance “e” is determined so as to fulfil a requirement represented by the following numerical expression:

p>e≥α/tan θ.

As long as the combination nut assembly meets the requirement, it is capable of accomplishing the locking accompanied by triple rocking effects only by a less-than-360° rotation, or a less-than-one rotation, of the second outer tightening nut.

Another preferred embodiment is characterized in that the combination nut assembly whose three nut components are put together in an unloaded fit condition without suffering external loads in the axial direction is wrapped in an open-ended breakable envelope. This envelope is preferably made of synthetic resin sheets such as preferably shrinkable transparent sheets. The combination nut assembly wrapped in the envelope keeps the unloaded fit condition, so that it can be engaged with the fastening bolt and located in the preparatory position all at once. Before fastening and locking operations are executed, the envelope is broken and removed, so as to eliminated troublesome operations for tightening the three nut components one by one. The combination nut assembly in the envelope can be not only easily handled in work fields and even in distribution industry but also is very efficient for use thereof.

### BRIEF DESCRIPTION OF THE DRAWINGS

The foregoing and other objects and features of the present invention will be clearly understood from the following detailed description when reading with reference to the accompanying drawings wherein:

FIG. 1 is a perspective view of a bolt-and-nut fastening device in accordance with the present invention;

FIG. 2 is an exploded sectional view of the combination nut assembly shown in FIG. 1 which is separated into three nut components;

FIG. 3A is a perspective view of the combination nut assembly matched up as an integrated single unit in an unloaded fit condition wherein the three nut components are fit together without suffering any external load;

FIG. 3B is a cross sectional view of the combination nut assembly shown in FIG. 2A matched up as an integrated single unit in the unloaded fit condition wherein the three nut components are fit together without suffering any external load;

FIG. 4 is an enlarged diagrammatic view showing a part enclosed by a broken line 4F in FIG. 3 for depicting a detailed geometric aspect of the three nut components in the unloaded fit condition;

FIG. 5 is a partial cross-sectional view of the combination nut assembly in accordance with the present invention which is in a preparatory position wherein the combination nut assembly is ready for fastening and locking;

FIG. 6 is a partial cross-sectional view, similar to FIG. 5, showing the combination nut assembly after fastening and locking of the combination nut assembly;

FIG. 7A is an enlarged illustration depicting a geometrical relative position between internal and external screw threads desirably engaged with each other;

FIG. 7B is an enlarged illustration depicting a geometrical relative position between a crest of the internal screw thread and a root of the external screw thread when the dual frustoconical inner locking nut is locked; and

FIG. 8 is a plane view showing an appearance of the combination nut assembly wrapped in an open-ended envelope.

### DETAILED DESCRIPTION OF THE PREFERRED EMBODIMENTS

A combination nut assembly in preferred embodiments according to the present invention will be hereinafter described with reference to the accompanying drawings in detail.

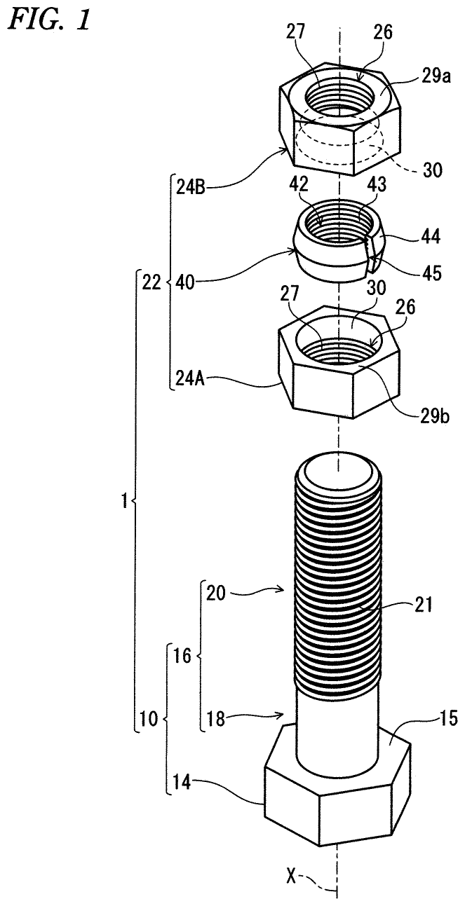

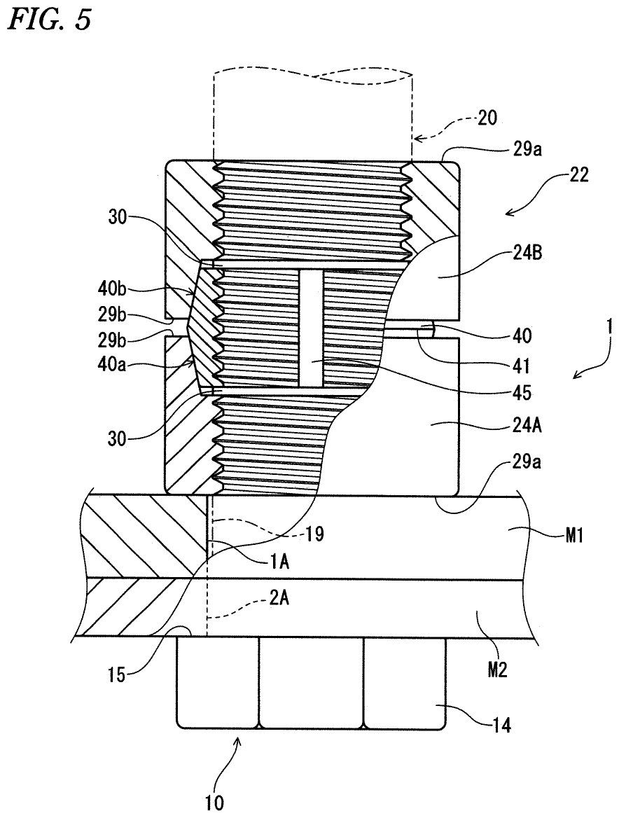

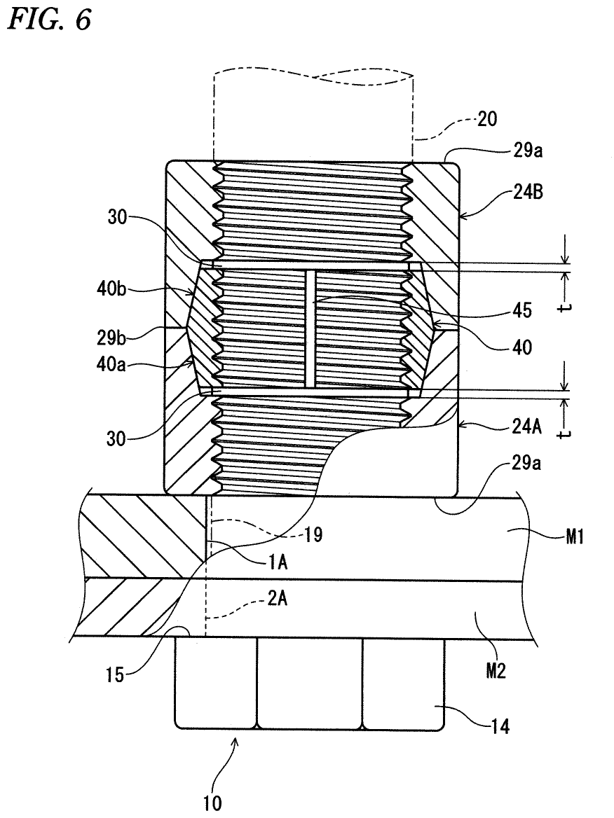

Referring to FIG. 1 showing a combination nut assembly in accordance with the present invention and a fastening bolt, a bolt-and-nut fastening device 1 for fastening object members, such as two planer members M1 and M2 (see FIGS. 5 and 6) to be fastened and connected tightly and securely together includes two components, namely a fastening bolt 10 which may be of any generally known type and a combination nut assembly 22 in accordance with a preferred embodiment of the present invention which is engageable with the fastening bolt 10. The fastening bolt 10 of, for example, the type of a hexagon head bolt such as conformity to Japanese Industrial Standard consists of a hexagon head 14 with a bearing surface 15 and a cylindrical rigid shaft 16 extending directly from the bearing surface 15. Any particular types fastening bolts can be available according to application targets. The cylindrical shaft 16 consists of an unthreaded shaft portion 18 and a threaded shaft 20 with an external screw thread 21 formed thereon and extends in a direction of a center axis X of the bolt-and-nut fastening device 1 including the combination nut assembly 22. The external screw thread 21 is, for instance in this embodiment, of the metric screw thread specified as having a nominal size M16 under Japanese Industrial Standard. In the use of the bolt-and-nut fastening device 1 in various work fields, the fastening bolt 10 is inserted first through holes 1A and 2A (see FIG. 5) formed respectively in planer members M1 and M2 to be fastened and firmly fixed together.

In the following description, because the outer tightening nuts 24A and 24B are exactly identical in outer appearance and interior configuration as well as in geometric measurements, it will be adequate to provide a following description with reference to either one of them, for instance the first outer tightening nut 24A, in order to avoid redundancy when suitable. Further, in the following description, same component parts of the first and second outer tightening nuts 24A and 24B are respectively denoted by the same reference signs throughout the accompanying figures.

The combination nut assembly 22 consists of three individual nut components, namely first and second outer tightening nuts 24A and 24B and a dual frustoconical inner locking nut 40. The first outer tightening nut 24A has a top surface 29a (see the second outer tightening nut 24B) and a bearing surface 29b at opposite ends respectively thereof and is provided with an axial through bore 26 with an internal screw thread 27 formed which is removably engageable with the external screw thread 21 of the fastening bolt 10 and a frustum-shaped fitting socket, more specifically an interior frustum-shaped fitting socket 30 directly adjacent to the threaded bore 26. The frustum-shaped fitting socket 30 is fit by a first half locking nut member 40a of the fustoconical inner locking nut 40 shaped in the form of an exterior frustum (which is referred to as a frustum-shaped first half locking nut member 40a) as will be described in detail later. The dual frustoconical inner locking nut 40 is made of an elastically deformable material.

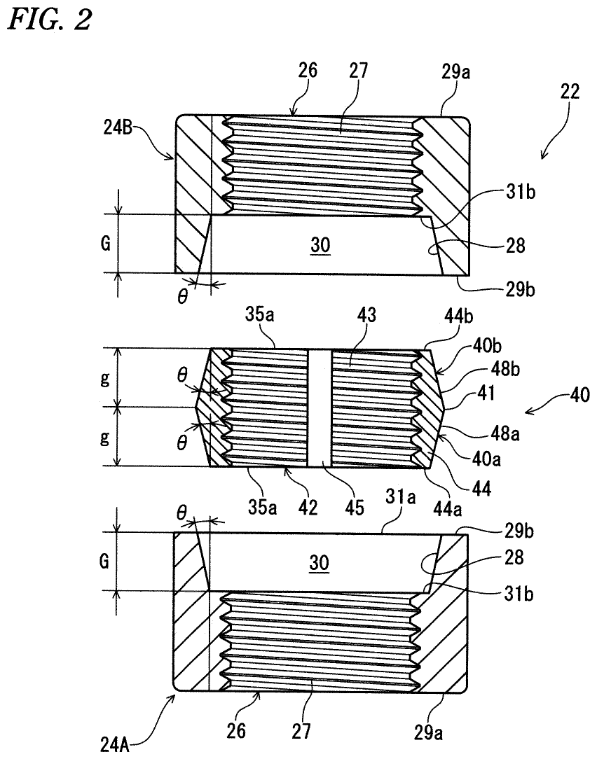

As shown in FIG. 2, the dual frustoconical inner locking nut 40 is made of two halves of the cylindrical hollow barrels each of which is shaped in the form of an exterior frustum. Although the dual frustoconical inner locking nut 40 appears as if it consists of two, first and second, separate frustum-shaped half locking nut members 40a and 40b, it is formed as an integrated single unit with these two frustum-shaped half locking nut members reversed and symmetrical in position and integrally connected to each other at their larger ends. The dual frustoconical inner locking nut 40 is provided with an axial through bore 42 having an internal screw thread 43 therein which extends axially over the overall length thereof and is removably engageable with the external screw thread 21 of the fastening bolt 10. The dual frustoconical inner locking nut 40 has a narrow vertical slot 45 extending axially over its overall length. Specifically, as shown in detail in FIG. 2, the dual frustoconical inner locking nut 40 is made with an elastically deformable barrel 44 having an outer appearance of a dual frustum shape, the first and second half locking nut members 40a and 40b which are exactly identical in geometric dimensions to each other. Because of the identical appearance and the identical geometrical configuration. As previously described, these two frustum-shaped half locking nut members 40a and 40b are symmetrically inversed in position with their larger diameter ends jointly together so as thereby to provide an inverted and plane-symmetrical frustoconical inner locking nut 40 (which is hereinafter referred to as a dual frustoconical inner locking nut when necessary). The frustoconical barrel wall 44 is further provided with the narrow vertical slot 45 axially extending throughout its overall length. When the frustum-shaped first and second half locking nut members 40a and 40b are forced to fit into the frustum-shaped fitting sockets 30 of the first and second outer tightening nuts 24A and 24B in opposite directions, the vertical slot 45 allows the dual frustoconical inner locking nut 40 to cause radial deformation with external loads directed toward the center axis X, so that the dual frustoconical inner locking nut 40 develops a reduction in diameter in a permissible range through its radial deformation.

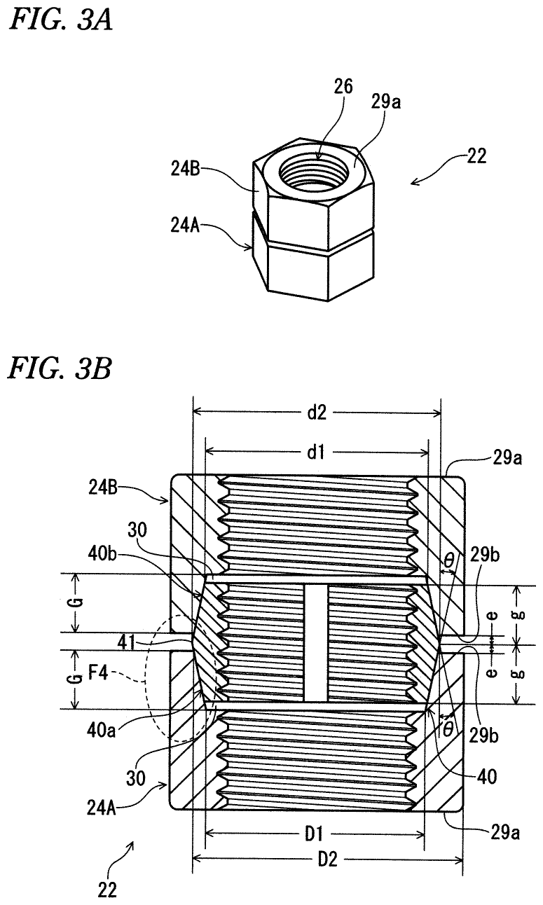

The three individual nut components, i.e., the outer tightening nuts 24A and 24B and the dual frustoconical inner locking 40, of the combination nut assembly 22 are the same in nominal size as the fastening bolt 10 of the bolt-and-nut fastening device 1. Further, while the outer tightening nuts 24A and 24B may be produced from either one of general steels, steels, etc. in generally common manufacturing methods, the dual frustoconical inner locking nut 40 is produced from elastically deformable materials preferably in a press molding method. As will be described later, it is preferable to carry and handle the three nut components 24A, 24B and 40 in the form of an integrated single unit even before engagement with the fastening bolt 10. As shown in FIGS. 3A and 3B showing the combination nut assembly 22 integrated in advance before fastening and locking the dual frustoconical inner locking nut 40, the individual outer tightening nut 24A is provided with the through bore 26 having the internal screw thread 27 on an inner surface thereof and the frustum-shaped fitting socket 30 coaxially adjoining to the threaded through bore 26. The frustum-shaped fitting socket 30 opens in a plane including the bearing surface 29b at the larger diameter end 31a and adjoins into the threaded bore 26 at the smaller diameter end 31b.

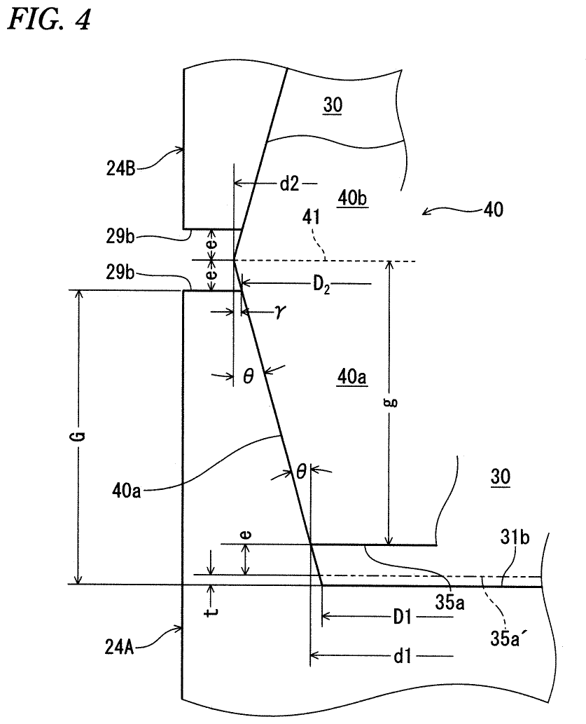

As shown in FIGS. 3B and 4, the frustum-shaped fitting socket 30 of the first outer tightening nut 24A is specified by an interior frustum having a larger end 31a with a diameter D2, a smaller end 31b with a diameter D1, a cone length G between the larger and smaller ends 31a and 31b and a generating line angle θ relative to the center axis X (half a cone angle 20). Here, the respective frustum-shaped half locking nut member 40a, 40b of the dual frustoconical inner locking nut 40 has a diameter d2 at its larger end 41 larger than that of the larger end of the frustum-shaped fitting socket 30 and a diameter d1 at its smaller end 35a smaller than the larger end D2 of the frustum-shaped fitting socket 30. Further, the respective frustum-shaped half locking nut member 40a, 40b of the dual frustoconical inner locking nut 40 has its overall length “g” smaller than a depth G of the frustum-shaped fitting socket 30. It is needless to say that the generating line angle θ and the cone length G of the frustum-shaped fitting socket 30 are properly determined in consideration with various mechanical and physical factors including nominal sizes, a rated tightening torque, etc. of the respective nut components of the combination nut assembly 22 as well as the fastening bolt 10 and a rated tightening torque with which connection members are fastened firmly and securely. The dual frustoconical inner locking nut 40 is, as previously described, shaped in the form of a dual frusta consisting of the frustum-shaped first and second half locking nut members 40a and 40b which are identical in geometrical configuration and arranged in symmetrically reversed positions with their larger diameter ends 41 joined together, so as thereby to provide a plane-symmetrical integral body. More specifically, each of the frustum-shaped first and second half locking nut members 40a and 40b is specified by an exterior frustum configuration having the larger end 41 (which is an imaginary plane including a circular ridge line 41 as clearly shown in FIG. 4 and common to the frustum-shaped first and second half locking nut members 40a and 40b) with the diameter d2 larger than the larger end diameter D2 of the frustum-shaped fitting socket 30, the smaller end 35a with the diameter d1 smaller than the larger end diameter D2 of the frustum-shaped fitting socket 30, a cone length or height “g” between the larger and smaller diameter ends 41 and 35a, and a generating line angle θ completely equal to that of the frustum-shaped fitting socket 30 of the outer tightening nut 24A.

Referring back to FIG. 3B, the combination nut assembly 22 illustrated as an integrated single unit consists of the three nut components, i.e., the outer tightening nuts 24A and 24B and the dual frustoconical inner locking nut 40. As apparent from FIG. 3B, the combination nut assembly 22 is built up in such an integrated single unit where the frustum-shaped first and second half locking nut members 40a and 40b forming the dual frustoconical inner locking nut 40 are fit into the frustum-shaped fitting sockets 30 of the first and second outer tightening nuts 24A and 24B respectively without suffering any external loads except for their own weights (gravity). For this integrating operation, first of all, the frustum-shaped first half locking nut member 40a of the dual frustoconical inner locking nut 40 is coaxially aligned with and dropped into the frustum-shaped fitting socket 30 of the first outer tightening nut 24A. Here, because the frustum-shaped first half locking nut member 40a has the lager end 41 larger in diameter than the larger end 31a of the frustum-shaped fitting socket 30 and the smaller end 35a smaller in diameter than the larger end 31a of the frustum-shaped fitting socket 30, and because the frustum-shaped first half locking nut member 40a of the dual frustoconical inner locking nut 40 and the frustum-shaped fitting sockets 30 of the first outer tightening nuts 24A have the same cone angles θ, the frustum-shaped first half locking nut member 40a of the dual frustoconical inner locking nut 40 is partly stowed in the frustum-shaped fitting socket 30 of the first outer tightening nut 24A without suffering any axial load and, however, restrained from completely entering into the same. In this position, the frustum-shaped first half locking nut member 40a protrudes from the larger end 31a of the first frustum-shaped fitting socket 30 which is even with the bearing surface 29b of the first outer tightening nut 24A by a predetermined length or distance (which is indicated by a reference sign “e”. This protrusion distance is a most important design factor in the determination of working efficiency for the combination nut assembly 22.

After the fitting operation of the frustum-shaped first half locking nut member 40a of the dual frustoconical inner locking nut 40 into the frustum-shaped fitting socket 30 of the first outer tightening nut 24A, the second outer tightening nut 24B is put on the frustum-shaped second half locking nut member 40b so as to fit into and partly stow it in the frustum-shaped fitting socket 30 thereof in the unloaded fit condition. In this second fitting operation, the second outer tightening nut 24B and the frustum-shaped second half locking nut member 40b of the dual frustoconical inner locking nut 40 are situated in an inversed geometric position. Accordingly, the explanation of the first fitting operation allies for the second fitting operation by replacing the first outer fastening nut 24A and the frustum-shaped first half locking nut member 40a with the second outer fastening nut 24B and the frustum-shaped second half locking nut member 40b. That is, the second outer tightening nut 24B is so placed on the frustum-shaped second half locking nut member 40b of the dual frustoconical inner locking nut 40 as to stow and retain the frustum-shaped second half locking nut member 40b with the hem protruded from the bearing surface 29b of the second outer tightening nut 24B. In this way, the dual frustoconical inner locking nut 40 is kept as the integrated single unit without suffering external axial loads. This condition where the frustum-shaped first and second half locking nut members 40a and 40b fit and partly stowed in the frustum-shaped fitting sockets 30 of the first and second outer tightening nuts 24A and 24B is referred to as an unloaded fit condition in this description. In the unloaded fit condition, the frustum-shaped first and second half locking nut members 40a and 40b always protrude from the bearing surfaces 29b by the predetermined axial distance “e”. Subsequently, the combination nut assembly 22 thus integrated as a single unit is picked up with fingers including a thumb and handled all together for engagement with the fastening bolt 10. For keeping the combination nut assembly 22 in the unloaded fit condition, the three nut components, particularly the first and second outer tightening nuts 24A and 24B, may be separably joined together with an auxiliary adhesive tape or by wrapping with a paper envelope.

Referring to FIG. 4 diagrammatically illustrating a geometric relation of a part of the integrated combination nut assembly 22 encircled and indicated by a reference sign 4F in FIG. 3B, as is previously described, the interior frustum-shaped fitting socket 30 of each outer tightening nut 24A, 24B has the cone depth G lager than the height “g” of each frustum-shaped half locking nut member 40a, 40b, the diameter D2 of the larger end 31a smaller than that of each frustum-shaped half locking nut member 40a, 40b, the diameter D1 of the smaller end 31b smaller than the diameter d1 of each frustum-shaped half locking nut member 40a, 40b, and the cone generating angle “θ” just same as each frustum-shaped half locking nut member 40a, 40b. The cone generating angle “θ” is determined as one of prerequisite conditions in consideration of various design factors including geometric shapes, physical properties, qualities of material and especially including an elastic modulus of the dual fustoconical inner locking nut 40. When the dual combination nut assembly 22 is properly located in the preparatory position (where the combination nut assembly is ready for subsequent fastening and fixing operation of the connection members as stated above) and under the unloaded fit condition, each frustum-shaped half locking nut member 40a, 40b is stowed partly in the frustum-shaped fitting socket 30 with the protrusion hem of the distance “e”, there is a clearance twice as large as the protrusion distance “e” between the bearing surfaces 29b of the first and second outer tightening nuts 24A and 24B. In FIG. 4, a reference sign “t” represents an axial distance of a clearance left between each frustum-shaped half locking nut member 40a, 40b of the dual frustoconical inner locking nut 40 and a bottom of the frustum-shaped fitting socket 30 of each outer tightening nut 24A, 24B when they are completely fit and stowed. These clearances left between the outer tightening nut 24A and 24B and the dual frustoconical inner locking nut 40 are provided for preventing them from getting inadequate interferences.

FIG. 5 shows the combination nut assembly 22 in the preparatory position where it is adequately integrated and put ready for fastening and locking of the combination nut assembly 22. For locating the combination nut assembly 22 integrated as a single unit into the preparatory position, the combination nut assembly 22 kept in the unloaded fit condition is picked up with fingers including a thumb. Then, the integrated combination nut assembly 22 is engaged with the fastening bolt 10 and screwed down to the preparatory position in an ordinary way as shown in FIG. 5. Although the integrated combination nut assembly 22 is preferably engaged and screwed down with the fingers at once, it may be allowed to engage the three nut components, i.e., the first outer tightening nut 24A, the dual fustoconical inner locking nut 40 and the second outer tightening nut 24B, with the fastening bolt 10 and screw down them to the preparatory position one by one in this order and adjusted to match the unloaded fit condition. Following the attainment of the preliminary position, the first outer tightening mut 24A is forced with a rated torque. This tightening operation is achieved by means of any available tightening tools or devices well known in the art. The combination nut assembly 22 is preferably required to maintain the unloaded fit condition in the preliminary position. If the combination nut assembly 22 is loosely joined in the unloaded fit condition in the preliminary position, it may be an efficient solution to adjust fitting of one or more individual nut components 24A, 24B and 40 so as to match approximately the unloaded fit condition. However, this adjustment is not always absolutely required. After the adjustment, the first outer tightening nut 24A is rotated and tightened with a rated torque by the use of a fastening tool or a fastening device well known in the art so as to fasten and fixe the planer members M1 and M2 firmly together between the bearing surface 15 of the bolt head 14 and the top surface 29a (which serves like a bearing surface in this embodiment) of the first outer tightening nut 24A with a rated axial tension. This fastening operation may be completed in such a controlled method as to control a rotation angle or a fastening torque. [h1] When employing the torque control method, it is general to use either one of a wrench, an impact wrench which stops in operation with specified torque, a pneumatically controlled wrench device operative for a fixed period of time at a specified air pressure, a hydraulically controlled wrench device which get hydraulically operative at a specified fastening torque and the like. The locking operation after the completion of the fastening operation for the planer members M1 and M2 is conducted for preventing at least either one of the nut components 24A, 24B and 40 from unfavorably unscrewing due to mechanical vibrations unintentionally imposed thereto which is accompanied by loosening of the combination nut assembly 22.

The locking operation is executed and completed by means of slight screwing of the second outer tightening nut 24A only. When screwing the second outer tightening nut 24B, there develops axial displacement through engagement with the fastening bolt 10. This develops large resisting force between an inner wall 28 of the frustum-shaped fitting socket 30 and an outer wall 48b of the frustum-shaped second half locking nut member 40b which is so sufficiently large as to create friction coupling like a cone clutch between the second outer tightening nut 24B and the dual frustoconical inner locking nut 40. Accordingly, while the second outer tightening nut 24B is screwed and displaced axially downward, the frustum-shaped second half locking nut member 40b, and hence the dual frustoconical inner locking nut 40, is forced to turn through the friction coupling and displaced downward through the engagement with the fastening bolt 10, so as to fit into the frustum-shaped fitting socket 30 of the first outer tightening nut 24A. Resultingly, while the dual frustoconical inner locking nut 40 is forced to turn and displace axially downward through the engagement with the fastening bolt 10, the frustum-shaped first half locking nut member 40a slides downward and fit into the frustum-shaped fitting socket 30 of the first outer tightening nut 24A while rotating. During the simultaneous axial displacement of the second outer tightening nut 24B and the dual fustoconical inner locking nut 40, the frustum-shaped first half locking nut member 40a is forcibly pressed radially over its length by the first and second outer tightening nuts 24A and 24B, so as to cause radial deformation which is uniform throughout. When the first and second outer fitting nuts 24A and 24B strikes each other at their bearing surfaces 29b, the dual frustoconical inner locking nut 40 is completely stowed within the frustum-shaped fitting sockets 30 of the first and second outer fastening nuts 24A and 24B. In the locking operation, the second outer tightening nut 24B is required to be rotated for accomplishing the locking of the dual frustoconical inner locking nut 40 is less than 360° which is quite small as will be described below. As apparent from FIGS. 5 and 6, the distance of the axial displacement required for the second outer tightening nut 24B to strike against the first outer tightening nut 24A is essentially equal to the axial protrusion distance “e” of the hem of each frustum-shaped half locking nut member 40a, 40b of the dual fustoconical inner locking nut 40 in the unloaded fit condition wherein each frustum-shaped half locking nut member 40a, 40b is retained by the frustum-shaped fitting socket 30 of each outer fastening nuts 24A, 24B.

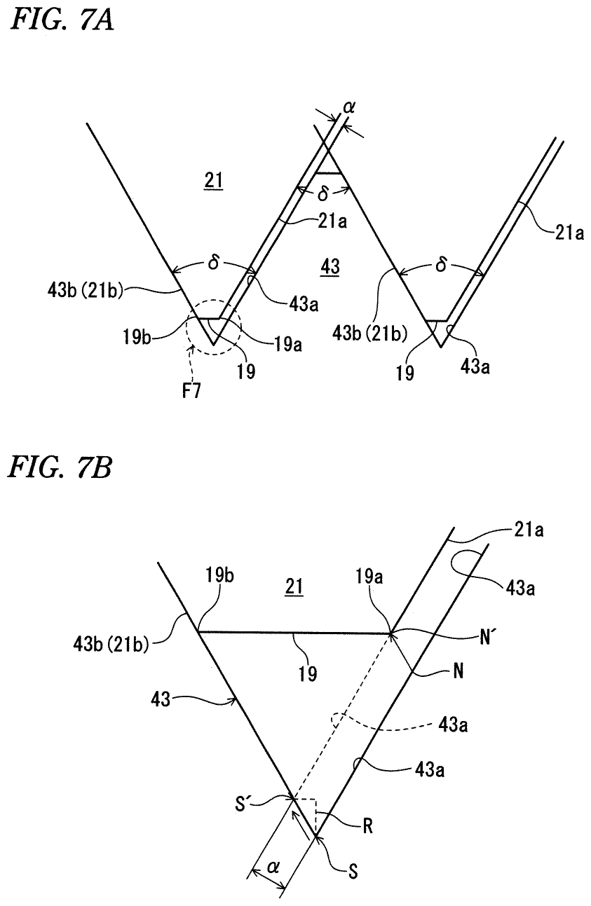

The locking mechanism will be described below with reference to FIG. 7A which illustrates ordinary engagement between the external screw thread 21 and the internal screw thread 43 before locking the combination nut assembly 22 and FIG. 7B which illustrates locking engagement between the external screw thread 21 and the internal screw thread 43 after locking encircled by a dotted circle F7 in FIG. 7A. In the diagrammatical illustration showing a locking mechanism between the external screw thread 21 of the fastening bolt 10 and the internal screw thread 43 of the dual frustoconical inner locking nut 40, these screw threads 21 and 43 are engaged in an ordinary way by means of fingers so as to conform with specified requirements in the preparatory position shown in FIG. 5. Shown in FIG. 7A is the case where the dual frustoconical inner locking nut 40 (the screw thread 43) advances right for engagement with the fastening bolt 10 which is fixed. Leading and clearance flanks of the internal screw thread 43 are represented by signs 43b and 43a respectively, and leading and clearance flanks of the external screw thread 21 are represented by signs 21b and 21a respectively. Further, a crest and opposite side edges of the crest of the external screw thread 21 are represented by signs 19, 19a and 19b respectively. In the case of nominal size M16, a thread angle (δ) of each screw thread 21, 43 is 60 degrees, accordingly, a flank angle (δ/2) of each screw thread 21, 43 is half the thread angle, i.e., 30 degrees. When the dual frustoconical inner locking nut 40 is ordinarily engaged with the fastening bolt 10 with fingers or a tightening tool and located in the preparatory position, there is a backlash of a width “α” left between the clearance flanks 21a and 43a of these external and internal screw threads 21 and 43.

Subsequently to the completion of the fastening operation of the first outer tightening nut 24A, when the second outer tightening nut 24B located in the preparatory position is forced to turn by means of a tightening tool or device well known in the art and to cause own axial displacement concurrently, it causes the frustum-shaped second half locking nut member 40b to deform elastically in the radial direction. Because of the axial displacement of the frustum-shaped second half locking nut member 40b and hence of the dual frustoconical inner locking nut 40. This axial displacement of the dual frustoconical inner locking nut 40 is accompanied by elastic deformation in the radial direction, so that the dual frustoconical inner locking nut 40 reduces its own diameter. While the internal screw thread 43 is deformed in a direction perpendicular to the center axis X, the leading flank 43b slides on the corresponding flank 21b of the external screw thread 21 of the fastening bolt 10. At this time, the clearance flank 43a moves until a point N on the clearance flank 43a occupies a position N′ on the side edge 19a of the crest 19 of the external screw thread 21 as illustrated in FIG. 7B. That is, an intersection S at which the leading and clearance flanks 43b and 43a of the internal screw thread 43 meet travels to a point S′ where the intersection S of the leading and clearance flanks 43b and 43a occupies at the time when the point N on the clearance flank 43a catches on a position N′ on the side edge 19a of the crest 19 of the external screw thread 21, so that the distance between the points S and S′ is just the same as the distance between the points N and N′. When the second outer tightening nut 42B is additionally forced to turn slightly after the clearance flank 43a of the internal screw thread 43 is struck strongly by the crest 19 of the clearance flank 21a of the external screw thread 21 at a point N′, the clearance flank 43a of the internal screw thread 43 encounters plastic deformation and, as a result, is bitten firmly by the side edge 19a of the crest 19 of the external screw thread 21, so that the dual frustoconical inner locking nut 40 grasps firmly the fastening bolt 10 and makes itself impossible to turn relatively with the fastening bolt 10. Consequently, the combination nut assembly 22 is firmly locked.

Here, a discussion is provided for the projection distance “e”. Because the flank angle δ/2 of the leading flank 43b is half the thread angle “δ” (60 degrees), when letting a travel distance of the intersection S to the point S′ along the leading flank 43b of the internal screw thread 43 be “M”, the radial distance R that the intersection travels in the radial direction can be represented by M·cos (δ/2). On the other hand, the backlash width “α” perpendicular to and between the clearance flanges 43a and 21a of the internal screw thread 43 and the external screw thread 21 can also be represented by M·cos (δ/2). Consequently, the radial traveling distance “R” is equal to the backlash width “α”.

As apparent from the description above, the traveling distance “R” represents the radial displacement of the flank intersection “S” in the direction perpendicular to the center axis X while the second outer tightening nut 24B displaces in the axial direction by a distance equal to the projection distance “e” until striking the first outer tightening nut 24A. As apparent from FIG. 4, when the second outer tightening nut 24B causes this axial displacement by the distance equal to the projection distance “e”, the dual frustoconical inner locking nut 40 is forced to deform elastically by a radial distance “r” and is, as a result, completely stowed in the frustum-shaped fitting sockets 30 of the first and second outer tightening nuts 24A and 24B. Because the interior frustum-shaped fitting sockets 30 of both the outer tightening nuts 24A and 24B and both the frustum-shaped half locking nut members 40a and 40b of the dual frustoconical inner locking nut 40 have the same cone generating angle “θ”, the radial distance “r” by which the dual frustoconical inner locking nut 40 deforms in the radial direction is expressed by the equation r=e·tan θ. As previously described, because the radial distance “r” of the elastic deformation of the dual frustoconical inner locking but 40 is exactly equivalent to the radial distance “R” which is the radial displacement of the intersection S of the leading and clearance flanges 43b and 43a of the internal screw thread 43. Therefore, it is apparent that the distances “r”, “R” and “α” are just the same, the projection distance “e” is represented by r/tan θ. Accordingly, the projection distance “e” can be reduced to the following equation:

e=α/tan θ

Further, it is apparent that a rotational angle “λ” which the second tightening nut 24A is required to displace axially downward by a distance equal to the protrusion distance “e” is expressed by the following equation when letting a pitch of the combination nut assembly be “p”:

λ=e·360°/p

When considering the locking operation executed in the inferior work fields, it is preferred to complete the locking operation as simple as possible. From this viewpoint, it is desirable for the combination nut assembly 22 that the projection distance “e” is determined so as to fulfil a requirement represented by the following inequality

p>e≥α/tan θ.

This requirement is essential for lastingly locking the combination nut assembly 22. This is because, if smaller than the value α/tan θ, the clearance flank 43a of the internal screw thread 43 cannot be bitten by the crest edge 19b of the crest 19 of each external screw thread 21, so that the dual frustoconical inner locking nut 40 encounters incomplete locking. On the other hand, if the requirement concerning the pitch “p” of each screw thread 21, 43 is ignored, the second tightening nut 24B is required to make a more-than-one rotation for locking the combination nut assembly 22. This makes the locking operation difficult and troublesome in the working field. As long as the combination nut assembly 22 meets the requirement, it is capable of accomplishing the locking operation only by less than one rotation of the second outer tightening nut 24B.

In the specific example where the cone generating angle “θ” is 11 degrees and the backlash width “a” is 0.05 mm, the axial distance “e” is approximately 0.26 mm. In this example, the locking of the combination nut assembly 22 is accomplished by forcibly rotating the second outer tightening nut 24B through a rotational angle “λ” of approximately 46 degrees. Thus, the locking of the combination nut assembly 22 is accomplished by means of only a less-than-one rotation of the second outer tightening nut 24A which is very advantageous to workers in inferior working fields.

Accelerated vibration tests were conducted in conformity to National Aerospace Standard (NAS) 3350 for the combination nut means 22 so as to evaluate its locking performance. When the three induvial component nuts 24A, 24B and 40 employed for the combination nut assembly 22 are of the nominal size of JIS M16 and of the coarse pitch thread type, each screw thread 27, 43 has the same pitch p of 2.0 mm. Each outer tightening nut 24A, 24B is specified as having a nominal axial length of 13 mm and a width across flats of 24.0 mm and has an internal-frustum-shaped fitting socket specified by dimensions such as a cone generating angle θ of 11°, an axial depth G of 5.0 mm, a larger end diameter D2 of 19.786 mm and a smaller end diameter D1. On the other hand, each half locking nut member 40a, 40b is specified by dimensions such as a cone generating angle θ of 11°, an overall axial length 2 g of 9.7 mm, a larger end diameter d2 of 20.0 mm. In the preparatory position shown in FIG. 5 where the combination nut assembly is ordinarily tightened with the three individual component, there is a backlash of the width α of 0.05 mm between active flanks of the internal screw thread of the dual frustoconical inner locking nut 40 and the external screw thread of the fastening bolt 10 of the bolt-and-nut fastening device 1. The dual frustoconical inner locking nut 40 which is partially stowed in and retained between the internal-frustum-shaped fitting socket 30 of the outer tightening nuts 24A and 24B in the unloaded fit condition. The accelerated vibration test was executed for three different tightening torques. That is, the bolt-and-nut fastening device was attached to a jig of the rigid mounting type specified by NAS3350 and a specified torqued at first with a tightening torque of 186 N·m, secondly with a tightening torque of 100 N·m and finally with 84.3 N·m. These accelerated vibration tests were executed under the following conditions such as a vibration frequency of 30 Hz, a vibration altitude of 114±0.4 mmp·p, an impact width of 19 mm and the number of vibrations of 30,000 continuously for 2 mins. and 40 secs.

The combination nut assembly is demonstrated according to looseness evaluations on the basis of the test results that whichever tightening torques the combination nut assembly was tightened with, it causes no looseness at all neither during nor after the accelerated vibration tests. In addition, a loosening torque that the combination nut assembly was loosed after the accelerated vibration test was the same as the tightening torque. The outcome of the accelerated vibration test demonstrates that an expected tightening torque necessary to the combination nut of nominal size M16 is not higher than 84.3 N·m. This reveal that how weak the tightening torque the combination nut assembly of the present invention requires to display a reliable loosening preventive performance is.

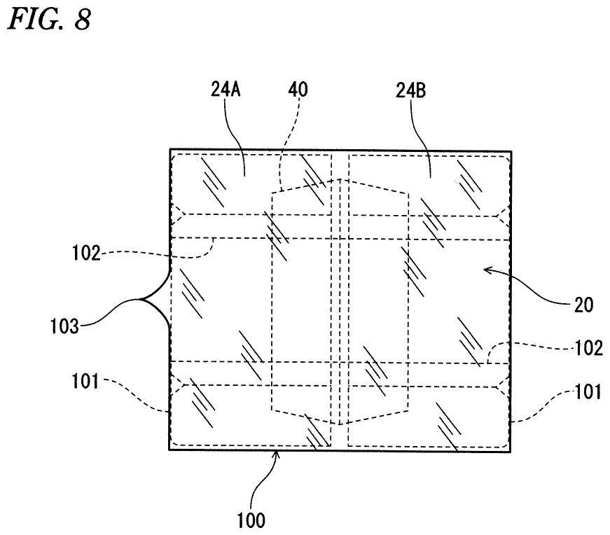

FIG. 8 shows a combination nut means according to another embodiment of the present invention which allows workers to carry out easy, safe and reliable field operations. The combination nut means 22, which is preassembled and maintained in the unloaded fit condition, is firmly wrapped in an open-ended cylindrical envelope 100 with its opposite axial ends exposed to the outside. This cylindrical envelope 100 is made of synthetic resin sheets such as preferably shrinkable sheet. The open-ended cylindrical envelope 100 is provided with a tab 103 jotting out from either of opposite circular ends 101 thereof and perforated lines 102 extending from one end to the second on both sides of the tab 103. The combination nut assembly 22 wrapped in the cylindrical envelope 100 keeps the three individual component nuts in the unloaded fit condition. If the cylindrical envelope 100 is heat shrinkable, it maintains the three individual component nuts 24A, 24B and 40 firmly fixed in the unloaded fit condition.

In the case of tightening the combination nut device 22 with the fastening bolt 10, after picking up the integrally wrapped combination nut device 22 with two fingers, or otherwise with three fingers and engaging either one of the first and second outer tightening nuts 24A and 24B first, it is screwed down all at once to the preparatory position all at once, while the three individual component nuts 24A, 24B and 40 fixedly maintained in the unloaded fit condition. In this operation, either of the opposite ends of the end the outer tightening nuts 24A and 24B may be get engaged with the fastening bolt 10 first. When the combination nut device 22 integrally wrapped in the open-ended cylindrical envelope 100 is screwed down to the preparatory position, the tab 103 of the open-ended cylindrical envelope 100 is pulled and torn along the perforated lines 102 to break the open-ended cylindrical envelope 100. Subsequently, after tightening the first outer tightening nut 24A with a specified torque, the second outer tightening nut 24B is forcibly rotated through an rotative angle λ so as thereby to cause the dual frustoconical inner locking nut 40 to yield a frictional turn by means of friction coupling and radial deformation of a distance r until the dual frustoconical inner locking nut 40 is completely stowed in and between the internal frustum-shaped fitting socket 30 of the first and second outer tightening nuts 24A and 24B. The slight rotation of the second outer tightening nut 24B is easily and swiftly executed and yields an enhanced and reliable locking capability of the combination nut assembly 22. If the combination nut assembly 22 encounters a phase shift between the screw threads of partially overlapping nut components engaged with the fastening bolt, the combination nut assembly 22 will causes interference between these screw threads which is accompanied by unintentional locking thereof. In order to eliminate such the unintentional locking, it is allowed to wrap the combination nut assembly 22 with the nut components preassembled together nearly the unloaded fit condition in the cylindrical envelope 100. That is, the dual frustoconical inner locking nut 40 may be fit in the internal frustum-shaped fitting socket 30 of each outer tightening nut 24A, 24B with the protrusion distance “e” made slightly larger than a prescribed distance. In such a case, after tearing and removing the cylindrical envelope 100, the combination nut assembly 22 is adjusted into the preparatory position and matched to the unloaded fit condition.

Instead of wrapping the combination nut assembly 22 in the envelope for making it into a unified single set, it may be a simple way to interconnect both outer tightening nuts 24A and 24B with the dual frustoconical inner locking nut 40 held therebetween by means of adhesive members such as adhesive sheets which are capable of adhering to and interconnecting side surfaces of both outer tightening nuts 4A and 24B and of peeling off therefrom. The adhesive members are preferably peeled off when the integrated combination nut assembly 22 is located in the preliminary position. Further, it may also be a simple way to fix a boundary between each outer tightening nut 24A, 24B and the dual frustoconical inner locking nut 40 with relatively weak adhesives. In this case, it is not always necessary to remove the adhesive for disconnection of the boundary between each outer tightening nut 24A, 24B and the dual frustoconical inner locking nut 40. In any case, the combination nut assembly 22 demonstrates reliable loosening prevention performance.

Although employed together with fastening bolts to fasten connection members tightly and securely as described above, the combination nut assembly 22 is available for fixing and maintaining positional limitations of reciprocating parts such as rotary joints of industrial robot arms which rotate on and reciprocates along a pivot shaft. The rotary joint of the industrial robot arm has to be precisely controlled to move between predetermined limits. Because although these limits have to be precisely fixed and maintained by means of lock nuts, conventional lock nuts are easily loosened through cyclic impacts from the limitation lock nuts. However, the combination nut assembly 22 of the present invention is securely fastened and strongly locked in any position on threaded shafts, so as to have the capability of fixing and maintaining the positional limitations for reciprocating parts.

It is to be understood that although the present invention has been described with regard to preferred embodiments thereof, various other embodiments and variants may occur to those skilled in the art, which are within the scope and spirit of the invention, and such other embodiments and variants are intended to be covered by the following claims.

What is claimed is:

1. A combination nut assembly with a facility for prevention of loosening which is used in combination with a threaded fastening bolt for fastening connection members between a head of said threaded fastening bolt and said combination nut assembly, said combination nut assembly comprising:
a pair of outer tightening nuts identical in geometric configuration and provided with a threaded through bore engageable with said threaded fastening bolt, each said outer tightening nut being provided with an interior frustum-shaped fitting socket opening into said threaded through bore, and
a dual frustoconical inner locking nut in the form of a hollow barrel provided with a threaded through bore engageable with said threaded fastening bolt and a slot extending over an axial length thereof, said inner locking nut consisting of two exterior frustum-shaped half locking nut members identical in geometric configuration which are symmetrically inverted in position and integrally connected together as a single part with larger ends thereof jointly connected,
wherein each said frustum-shaped half locking nut member has a cone generating angle just the same as said interior frustum-shaped fitting socket, a cone height smaller than a depth of said interior frustum-shaped fitting socket, a larger end diameter larger than a larger end diameter of said interior frustum-shaped fitting socket, a smaller end diameter smaller than said larger end diameter of said interior frustum-shaped fitting socket, and
wherein, letting said cone generating angle be “θ”, an axial distance “e” of a protrusion of each said exterior frustum-shaped half lock nut member from a bearing surface of said outer tightening nut when each said locking nut member is fit in and retained by said frustum-shaped fitting socket of each said outer tightening nut under an unloaded fit condition be “e”, and a perpendicular backlash provided between flanks of screw threads of said fastening bolt and said inner locking nut when said fastening bolt and said inner locking nut are ordinarily engaged be “α”, said axial distance “e” of said protrusion of each said exterior frustum-shaped half nut member is determined so as to satisfy the following equation:
e=α/tan θ.

2. The combination nut assembly as defied in claim 1, wherein, when letting a pitch of said internal and external screw threads of said fastening bolt and said dual frustoconical inner locking nut be “p”, said axial distance “e” is determined so as to satisfy the following condition.
p>e≥α/tan θ.

3. The combination nut assembly as defied in claim 2, wherein said frustum-shaped fitting socket of each said outer tightening nut has a depth so as to leave a clearance between bottoms of each said frustum-shaped half locking nut member and each said frustum-shaped fitting socket of said outer tightening nut whose axial distance is less than said pitch of said dual frustoconical inner locking nut when said outer tightening nuts at their bearing surfaces abut against each other.

4. The combination nut assembly as defied in claim 2, wherein at least one of outer surface of said dual frustoconical inner locking nut, an inner surface of said interior frustum-shaped fitting socket and said bearing surface of each said outer tightening nut is completed with a stain-embossed finish.

5. The combination nut assembly as defied in claim 2, wherein said pair of said outer tightening nuts are interconnected with said dual frustoconical inner locking nut held therebetween by means of removable adhesive members.

6. The combination nut assembly as defied in claim 2, further consisting of an open-ended envelope for enclosing said pair of said outer tightening nuts with said dual frustoconical inner locking nut held therebetween which are preassembled in a nearly unloaded condition.
